(19) United States
(12) Patent Application Publication
(10) Pub. No.: US 2016/0244161 A1
(43) Pub. Date: Aug. 25, 2016

(54) UNMANNED AIRCRAFT HAVING FLIGHT LIMITATIONS

(71) Applicant: Daniel R. McClure, Alpharetta, GA (US)

(72) Inventor: Daniel R. McClure, Alpharetta, GA (US)

(21) Appl. No.: 15/043,673

(22) Filed: Feb. 15, 2016

Related U.S. Application Data
(60) Provisional application No. 62/119,705, filed on Feb. 23, 2015.

(51) Int. Cl. B64C 39/02; G01C 5/00; G05D 1/04

(52) U.S. Cl. CPC B64C 39/024; G05D 1/042; G01C 5/005; B64C 2201/021; B64C 2201/024; B64C 2201/145

(57) ABSTRACT

An unmanned aerial vehicle (UAV) having flight control components for controlling the speed, altitude, and direction of flight of the UAV. A control circuit is configured to generate flight control outputs that control the flight control components. A receiver receives flight control inputs from a remote controller, wherein the received flight control inputs are utilized by the control circuit to generate the flight control outputs. An altitude determining circuit configured to determine an altitude of the UAV. An altitude override circuit, embodied in the control circuit, operative when the altitude is determined to exceed a predetermined altitude limit, and configured to override conflicting flight control inputs and generate flight control outputs to control the flight control components to reduce the altitude of the UAV.

### CROSS-REFERENCE TO RELATED APPLICATION

The present application claims the benefit of U.S. Provisional Application Ser. No. 62/119,705, filed Feb. 23, 2015, the contents of which are incorporated hereby by reference.

### TECHNICAL FIELD

The present disclosure generally relates to unmanned aerial vehicles

(UAVs) (also, often referred to as drones), and more particularly to UAVs having preset flight limitations.

### BACKGROUND

UAVs, whether fixed wing or rotary (e.g., quad-copters), have become widely used for a variety of reasons (e.g., recreational, photography, etc.). In recent years, flight control systems for UAVs have become quite user friendly, permitting a wide range of users to quickly and easily learn to fly them.

A typical UAV flight controller is in the form of a handheld radio controlled transmitter, providing the user with basic controls for thrust, yaw, pitch, and roll for fixed-wing UAVs, and other similar basic controls for thrust/speed and directional controls for propeller-type UAVs (e.g., quad copters).

Certain automatic modes of operation are also known. For example, autopilot modes, wherein the UAVs can be programmed to fly a pre-programmed flight path. Other modes are known that provide a safe return of a UAV to a flight starting point. In such a mode, a user can press a button on the controller, and the UAV will fly back to its starting point.

Various features and implementations of prior art UAVs are described in U.S. Pat. No. 6,847,865, U.S. Pat. No. 6,856,894, U.S. Pat. No. 7,107,148, U.S. Pat. No. 7,228,232, U.S. Pat. No. 8,543,265, U.S. Published Application 2006/0138277, U.S. Published Application 2011/0049290, U.S. Published Application 2011/0221692, U.S. Published Application 2011/0257813, U.S. Published Application 2011/0288696, U.S. Published Application 2013/0325217, and U.S. Published Application 2014/0254896. The contents of each of these patents and published applications are hereby incorporated by reference.

Despite the wide-ranging features presently offered on UAVs, it is desired to provide UAVs having improved features, safety, and performance.

### SUMMARY

Briefly described, one embodiment, among others, a UAV is provided with circuitry or other on-board control to limit the altitude of the UAV to a predetermined maximum. That is, upon reaching the predetermined maximum altitude, on-board controls or circuitry operate to limit the flight controls such that the UAV is prevented from climbing any higher, regardless of conflicting user control inputs.

In another embodiment, a UAV is provided with circuitry or other on-board control to prevent the UAV from flying into proscribed airspace. In this embodiment, on-board circuitry determines a current spatial position of the UAV, assess whether that determined position is within a proscribed airspace, and if so overrides user directional controls to direct the UAV out of the proscribed airspace.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram illustrating certain components in conventional UAV systems;

FIG. 2 is a block diagram illustrating certain components an UAV systems constructed in accordance with embodiments of the present invention;

FIG. 3 is a flowchart illustrating an embodiment of the present invention; and

FIG. 4 is a flowchart illustrating an alternative embodiment of the present invention.

FIG. 5 is a flowchart illustrating an alternative embodiment of the present invention.

### DETAILED DESCRIPTION

### Glossary of Terms

Certain particular terms used in this application are defined below.

Altitude—Commonly, there are various uses of the “altitude.” There are “pressure altitude,” “density altitude,” altitude in reference to sea level, and altitude with reference to the ground. Unless otherwise noted, as used herein, the term “altitude” shall mean the height of an object (e.g., UAV) or point in relation to the ground level at a point underneath the object or point.

Automatic Dependent Surveillance-Broadcast (ADS-B)—is a cooperative surveillance technology in which an aircraft determines its position via satellite navigation and periodically broadcasts it, enabling it to be tracked.

Controlled Airspace—An airspace of defined dimensions within which ATC service is provided to IFR flights and to VFR flights in accordance with the airspace classification. Controlled airspace is a generic term that covers Class A, Class B, Class C, Class D, and Class E airspace areas. Controlled airspace is also that airspace within which all aircraft operators are subject to certain pilot qualifications, operating rules, and equipment requirements in 14 CFR part 91.

Class-A Airspace—Generally, that airspace from 18,000 feet MSL up to and including FL 600, including the airspace overlying the waters within 12 nautical miles (NM) of the coast of the 48 contiguous States and Alaska.

Unless otherwise authorized, all persons must operate their aircraft under IFR (instrument flight rules).

Class B Airspace—Generally, that airspace from the surface to 10,000 feet mean sea level (MSL) surrounding the nation's busiest airports in terms of airport operations or passenger enplanements. The configuration of each Class B airspace area is individually tailored and consists of a surface area and two or more layers, and is designed to contain all published instrument procedures. An ATC clearance is required for all aircraft to operate in the area, and all aircraft that are so cleared receive separation services within the airspace. The cloud clearance requirement for VFR operations is “clear of clouds.”

Class C Airspace—Generally, that airspace from the surface to 4,000 feet above the airport elevation (charted in MSL) surrounding those airports that have an operational control tower, are serviced by a radar approach control, and that have a certain number of IFR operations or passenger enplanements. Although the configuration of each Class C area is individually tailored, the airspace usually consists of a surface area with a 5 NM radius, an outer circle with a 10 NM radius that extends from no lower than 1,200 feet up to 4,000 feet above the airport elevation. Each person must establish two-way radio communications with the ATC facility providing air traffic services prior to entering the airspace and thereafter maintain those communications while within the airspace.

Class D Airspace—Generally, that airspace from the surface to 2,500 feet above the airport elevation (charted in MSL) surrounding those airports that have an operational control tower. The configuration of each Class D airspace area is individually tailored and when instrument procedures are published, the airspace will normally be designed to contain the procedures. Arrival extensions for instrument approach procedures may be Class D or Class E airspace. Unless otherwise authorized, each person must establish two-way radio communications with the ATC facility providing air traffic services prior to entering the airspace and thereafter maintain those communications while in the airspace. No separation services are provided to VFR aircraft.

Class E Airspace—Generally, if the airspace is not Class A, Class B,

Class C, or Class D, and it is controlled airspace, it is Class E airspace.

Uncontrolled Airspace—Airspace that has not otherwise been designated as Class A, Class B, Class C, Class D, or Class E airspace.

Mode-S transponder—The Mode S is a secondary surveillance and communication system which supports Air Traffic Control (ATC). Each Mode S transponder equipped aircraft is assigned a unique address code. Using this unique code, interrogations can be directed to a particular aircraft and replies can be unambiguously identified. Mode S limits as interrogations to specific targets, and proper timing of interrogations permits replies from closely spaced aircraft to be received without mutual interference. Mode S also provides monopulse detection for improved azimuth accuracy and includes RMM capabilities. The Mode S also interrogates and receives aircraft position and altitude information from Air Traffic Control Radar Beacon System (ATCRBS) transponder equipped aircraft.

Prohibited Areas—Prohibited areas contain airspace of defined dimensions identified by an area on the surface of the earth within which the flight of aircraft is prohibited. Such areas are established for security or other reasons associated with the national welfare. These areas are published in the Federal Register and are depicted on aeronautical charts.

Restricted Airspace—is airspace established under 14 CFR part 73 provisions, within which the flight of aircraft, while not wholly prohibited, is subject to restriction.

Squawk code (also known as “Transponder code”)—a four-digit number sent out by an aircraft's transponder.

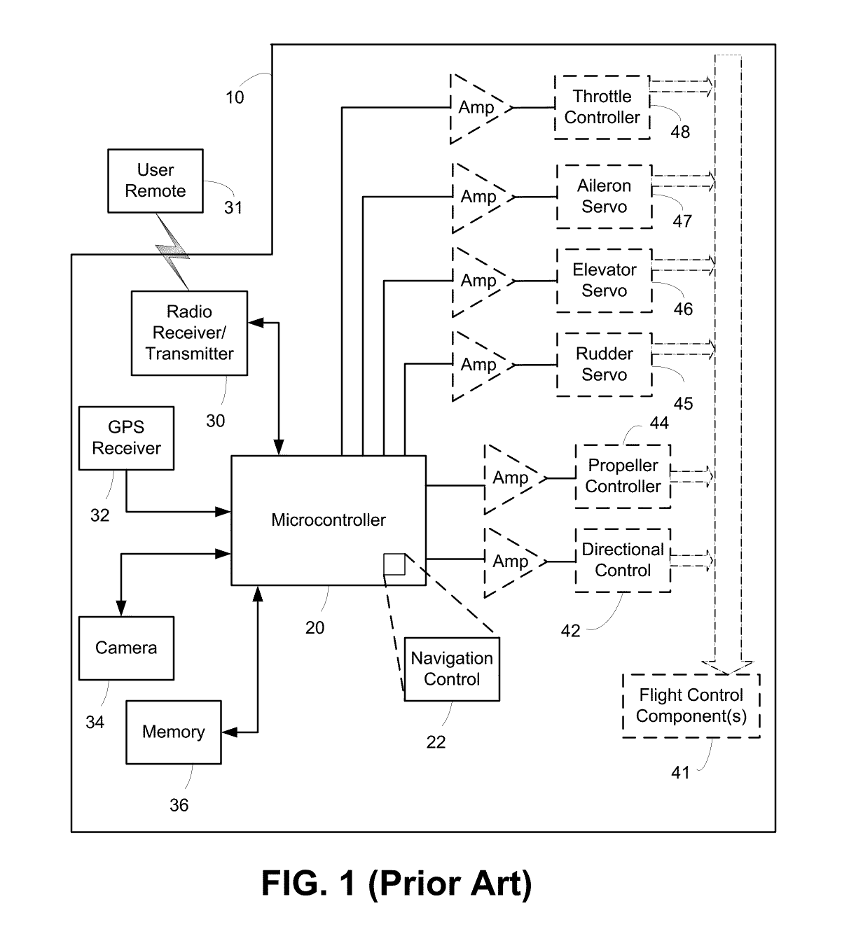

Reference is made to FIG. 1, which is a block diagram showing basic components in known UAV flight control systems. The discussion of FIG. 1 will be relatively brief, as the structure, function, and operation of prior art UAVs and their systems are well known and understood by persons skilled in the art. In FIG. 1, reference numeral 10 is used to designate a UAV. In FIG. 1, the UAV is merely designated as a box, but it is understood that UAVs come in a wide variety of shapes, sizes, and configurations. For example, there are fixed-wing UAVs, rotary UAVs (e.g., helicopters), and multi-propeller UAVs (e.g., quad copters). UAVs may be propelled by gas powered engines, or battery—operated electric motors. As will be appreciated that the description herein, the present invention is equally applicable to all UAV forms and configurations.

All UAVs include some form of flight control components 41. The specific flight control components will vary based upon the particular shape and configuration of the UAV. For example, on a fixed-wing UAV, conventional flight control components include a rudder, an elevator, and ailerons. Typically, these flight control components 41 are controlled by servo motors, such as a rudder servo 45, and elevator servo 46, and an aileron servo 47. Thrust for most fixed-wing UAVs will be provided by one or more propeller to engines/motors or one or more jet or turbofan engines. A throttle controller 48 is provided for controlling the thrust of the one or more engines/motors. The flight control operations of such conventional UAVs are well known and need not be described herein. Suffice it to say, persons having ordinary skill in the art will understand how to implement such components, depending upon the structural configuration of the particular UAV 10.

Similarly, FIG. 1 illustrates blocks labeled as directional control 42 and propeller controller 44. These blocks are used to designate the control of components for flight control systems in rotary UAVs. The various flight control 41 block and controller blocks 42, 44, 45, 46, 47, and 48 has been illustrated in-line, as not all of these components are implemented in a single UAV. That is, blocks 45, 46, 47, and 48 are typically implemented in fixed-wing UAVs, whereas blocks 42 and 44 are typically implemented in rotary-type UAVs. Further, the directional control 42 component(s) may vary depending upon the particular structure of the UAV. In a rotary-type UAV, the propeller controller 44 in concert with the directional control 42 will control the one or more propellers and flight control components as appropriate to deliver proper speed and direction to the UAV, as dictated by a user via a remote control 31. Again, these flight control operations are well known and understood by persons skilled in the art, and therefore need not be described herein.

A microcontroller 20 is illustrated as providing centralized control within the UAV 10. It will be appreciated that such a microcontroller 20 may be implemented in a variety of forms. For example, it may be a general purpose microprocessor or microcontroller chip, which operates in conjunction with, and under the control of, program code that is stored in a memory 36. Alternatively, the microcontroller 20 may be in the form of one or more dedicated circuits that work collectively to perform the overall control functions within the UAV 10. As one function of the microcontroller 20, navigation control 22 is provided for the UAV. As is known, in some UAVs preprogrammed flight paths may be uploaded to the UAV, and the UAV thereafter automatically flies along the predetermined flightpath. In other embodiments, a user provides real-time control inputs through the user's remote 31. Electrical signals representing those control inputs are transmitted to the UAV 10, where they are received by a radio frequency (or RF) receiver/transmitter 30. Those signals are then communicated to the microcontroller 20, where they are processed, in part in conjunction with the navigation control 22, to generate output signals for the various flight control components. As illustrated, amplifiers (labeled in FIG. 1 as “Amp”) may be provided for providing appropriate amplification (as well as digital to analog conversion) to the signals output from the microcontroller circuit 20.

A memory 36 may also be provided in conjunction with the microcontroller circuit 20. Program code, as well as data, may be stored in memory 36 in order to, in conjunction with the microcontroller 20 and other components, carry out the functions and operations of the UAV subsystems.

Many UAVs also come equipped with a camera 34 for taking aerial photographs and/or video. The photographs and/or video may be stored in memory 36 for later access by the user, or may be streamed back to the user's remote control 31 via the communication feed between the UAV 10 and the user's remote 31.

Finally, many UAVs are equipped with a GPS receiver 32, which may be used in conjunction with the navigation control 22.

Again, the foregoing merely provides a high-level description of certain features that are well known in conventional UAVs. Additional features and subsystems may also be known, but need not be described herein in order to attain a full and complete understanding of the present invention.

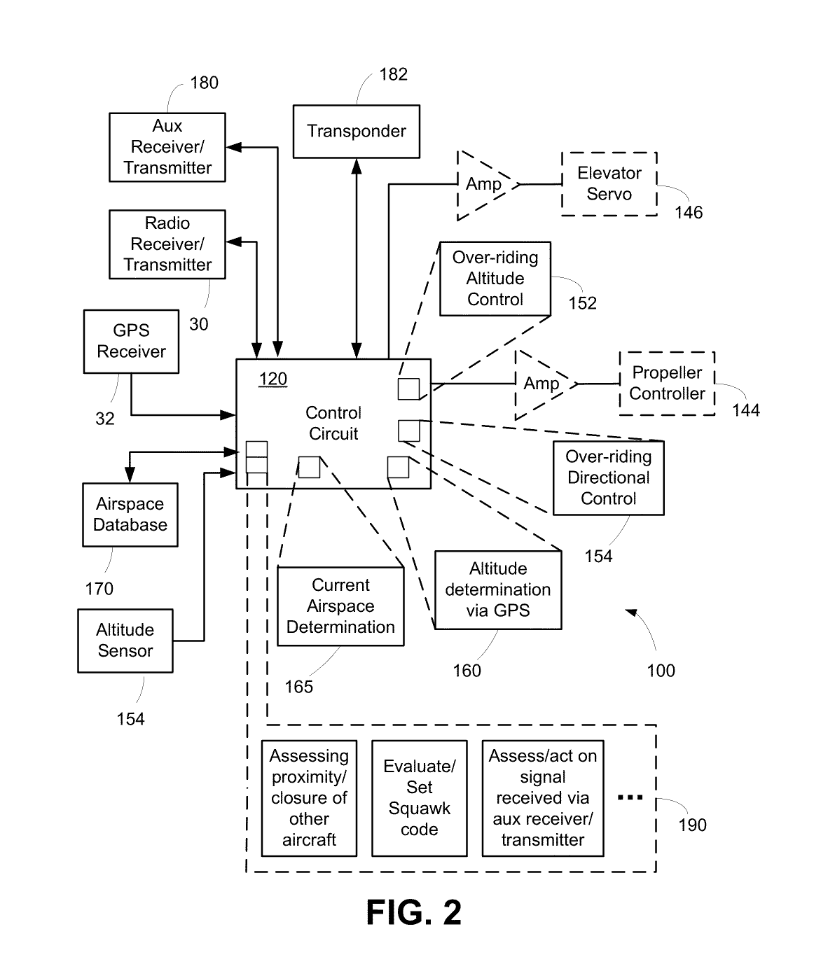

Having set forth the foregoing summary description of conventional UAVs and certain subsystems thereof, reference is now made to FIG. 2, which is a block diagram illustrating certain circuits, sub-circuits, and other fundamental components of various embodiments of the present invention. Before specifically describing the features illustrated in FIG. 2, a general description of embodiments of the present invention will be provided.

In view of the description herein, it will be understood by persons skilled in the art that the embodiments of the present invention provide UAVs providing improved safety and privacy for the general public. For example, UAVs having operational cameras may be flown into areas where other people have a general expectation of privacy. Likewise, UAVs may be flown in airspace where manned aircraft are flying, presenting a risk of midair collisions. To address these and other shortfalls of conventional UAVs, embodiments of the present invention provide for improved public safety, as well as privacy.

In one embodiment, an altitude override control may be imposed on the UAV. That is, the UAV may be preconfigured with a maximum altitude to which it is allowed to fly. Despite the capability of the UAV to fly at higher altitudes, upon reaching a certain, predetermined altitude, built-in control circuitry of the UAV provides control signals to the flight control components that otherwise override the user control inputs and limit the altitude to which the UAV may fly. In certain embodiments, this preconfigured or predetermined maximum altitude may vary, based upon the geographic location of the UAV. For example, in certain locations the maximum altitude may be predefined to be 500 feet. In other locations (e.g. sparsely populated or mountainous areas), the preconfigured altitude may be much higher (e.g., 2000 feet or more).

In another embodiment, the UAV may be configured to determine its current spatial location. This may be most readily ascertained to the use of a GPS receiver 32. The determined spatial location can then be correlated with database information regarding terrain, airspace, and other relevant information. Airspace Determination circuit 165 may provide this function. In this regard, in the aviation industry GPS databases are typically populated with both terrain and airspace information (e.g. restricted airspace, prohibited airspace, Class A, class B, Class C, and Class D airspace, etc.). Embodiments of the present invention may also (or alternatively) be implemented with directional overriding control circuitry, such that if it is determined based upon the current spatial location of the UAV that the UAV is entering a proscribed airspace or area, then the control signals to the flight control components are overridden (despite user control inputs to the contrary) to direct the UAV away from the proscribed airspace.

As used herein, the term “proscribed airspace” shall mean an airspace to which it has been determined that the UAV should not enter, whether it be for reasons of safety, privacy, legality, or other reasons. Examples of proscribed airspace mentioned above included restricted airspace, prohibited airspace, Class A, class B, Class C, and Class D airspace. All of these types of airspace are well known and understood in the aviation industry, as they are designated on aeronautical charts published by the Federal Aviation Administration. It is understood, however, consistent with the scope and spirit of the present invention, that additional or fewer airspace areas may be included in the proscribed airspace described herein. For example, heavily populated metropolitan areas may be deemed to be proscribed airspace areas, for purposes of public privacy.

In accordance with certain embodiments, geographic or spatial restrictions may not only be pre-defined by factors such as airspace classifications, but may be dynamically adjusted. For example, consider an area of an active crime scene, fire, or other newsworthy event. Such an area may attract media or law-enforcement helicopters or other areal vehicles, and in cases like this, it may be desired to prohibit UAV flight into certain areas. Consistent with embodiments of the invention, such airspace delimiters may be communicated to the UAV on the fly (i.e., in real time), thereby overriding user controls and preventing the UAV from flight into the restricted area. Likewise, public or special events may be held in certain areas, and temporary flight restrictions of UAV flight may be imposed in these areas during times of the events. A radio receiver on-board the UAV may be used to communicate parameters of such restricted airspace.

In accordance with other embodiments of the present invention, the UAV may be equipped with a transponder, and configured to transmit its own squawk code. As is known by persons skilled in the art, a UAV that is transmitting a squawk code is visible to air traffic control, and therefore presents less of a public safety hazard, as air traffic control could alert passenger or other manned aircraft of the location and altitude of the UAV. Therefore, in some embodiments of the present invention, the UAV may be permitted to continue flight in otherwise proscribed airspace, if it is transmitting a squawk code. In most embodiments, the mere presence of an operating transponder will not provide completely unrestricted flight of the UAV, but will instead provide an expanded airspace territory into which the UAV may be permitted to fly. As an example, in one embodiment a UAV that is not equipped with the transponder may be prohibited from flying in or over Class D airspace. If, however, the UAV is equipped with an operating transponder, then flight over top of Class D airspace may be permitted, while restricting flight within the Class D airspace. In such an embodiment, if the UAV detects that it is entering Class D airspace, user inputs are overridden such that the UAV is directionally turned to avoid the Class D airspace. If the user continues to direct the UAV toward the Class D airspace, then the UAV may be controlled to increase its altitude sufficient to cross over top of the class D airspace.

With this general description presented, reference is now made to FIG. 2, which is a block diagram illustrating certain basic components of a UAV 100 constructed in accordance with embodiments of the present invention. As illustrated in connection with FIG. 1, a central control circuit 120 is illustrated. It will be understood by persons skilled in the art, that the control circuit 120 may take on a variety of forms. For example, the control circuit 120 may be implemented as one or more general-purpose microprocessors or microcontrollers, or may alternatively be implemented as one or more dedicated circuits for interfacing with, and controlling the various components of the invention. As described in connection with FIG. 1, an RF receiver/transmitter 30 and GPS receiver 32 may be provided. Their implementation is similar to that of conventional systems, and therefore need not be described herein.

In altitude sensor 154 may be provided in some embodiments of the present invention. Systems and mechanisms for detecting a current altitude above ground are known, and therefore need not be exhaustively described herein. For example, in one implementation a beacon signal may be transmitted directionally downward. Receiver circuitry may be configured to receive and identify the return signal (reflected from the ground). Timing circuitry may be provided to time the signal delay between transmission and reception of the reflected/return signal, and that measured timing can be used to compute the instantaneous altitude. Such altitude sensor circuitry may not been provided, or necessary, in UAVs equipped with a GPS receiver, as altitude information may be computed based on the spatial location ascertained in connection with the GPS receiver (e.g., based on GPS-determined location, in conjunction with terrain and/or airspace information).

Overriding altitude control circuitry 152 may be provided in connection with the control circuit 120 in certain embodiments of the present invention. As summarily described above, such circuitry is configured to override conflicting user control inputs when the current altitude of the UAV is determined to exceed a predetermined or prescribed acceptable altitude. In simple terms, despite a user inputting controls to direct the UAV to fly higher (and despite the UAV's ability to fly at a higher altitude), the overriding altitude control circuitry 152 operates to control the signals output to the flight control components (e.g., signal sent to the elevator servo 146 or propeller controller(s) 144, etc.) such that the flight altitude of the UAV is limited. As referenced herein, the user control inputs include real-time control inputs from a user (e.g., via a remote control) or via a pre-programmed flight-path uploaded by a user into the UAV prior to a flight.

As mentioned above, in UAVs equipped with a GPS receiver 32, the instantaneous altitude of the UAV may be computed based upon the determined instantaneous spatial location of the UAV. Such a determination module or circuitry is illustrated in FIG. 2 by reference numeral 160. In simple terms, the current spatial location of the UAV may be assessed in conjunction with an aeronautical, airspace, and/or terrain database 172 ascertain the current altitude of the UAV. In this regard, as is known, GPS databases having navigational or airspace data include ground elevations (as well as mountains, towers, and other obstruction elevation information). Therefore, instantaneous altitude is can be readily computed based upon the determined spatial location of the UAV (which would include altitude above sea level) and the ground elevation of the location directly underneath the UAV.

In certain embodiments of the present invention, an auxiliary receiver/transmitter 180 may be provided. Such auxiliary receiver transmitter 180 may be used to provide other levels of communication in conjunction with air traffic control. As one example, the auxiliary receiver/transmitter 180 may include the ability to transmit and receive ADS-B data, which can provide location and altitude information of the UAV to air traffic control. Likewise, embodiments of the present invention may include a transponder 182, which permits the UAV to transmit a squawk code, which can be seen by ATC, as well as other aircraft having ADS-B compliant receivers, or mode S transponders (assuming the transponder 182 is a mode S transponder as well).

Like the overriding altitude control circuit 152, an overriding directional control circuit 154 may also be provided in certain embodiments of the invention. Upon a determination that the UAV is in, or is about to enter, proscribed airspace, the overriding directional control circuit 154 can override user control input signals, and control the directional flight of the UAV such that it avoids or exits proscribed airspace. When this occurs, an appropriate message may be communicated (electronically) back to the user's remote control via the RF receiver/transmitter 30. In this regard, the user's remote control may include in LCD display screen, or other indicator, which would notify the user that the user's flight controls are currently being overridden.

Various proscribed air spaces have been described above. In certain embodiments of the present invention, proscribed airspace is may be altered in real time based on signals received through the auxiliary receiver transmitter 180. That is, ADS-B communications (or other signaling) may provide real-time information to the UAV ever changing conditions, thereby changing proscribed airspace in real-time.

In certain embodiments, the transponder 182 may be configured with a squawk code that is unique to the UAV. This could permit the UAV to be “painted” on the display screens of air traffic control (as well as other nearby aircraft) as a UAV. This would assist pilots of manned aircraft to better “see and avoid” the UAV, by informing them of the type of aircraft they are looking for.

In embodiments of the invention that receive real-time data regarding the proximity of other aircraft, the overriding directional control circuit 154 may also be utilized to override user controls in order to avoid midair collisions with other aircraft. As is known, S mode transponders include traffic information of nearby aircraft equipped with S mode transponders. Likewise, ADS-B communications include positional information of nearby aircraft. Upon receiving a signal indicating a nearby aircraft, the overriding directional control circuit 154 could cause the UAV to take immediate and decisive action (well in advance of a midair collision) to avoid even being in the proximity of other aircraft (that is, the UAV could direct itself away from another aircraft before even getting close enough to generate a warning on the other aircraft's traffic alert system).

In yet other embodiments of the invention, the UAV may be configured to permit an over-riding remote control signal to take directional control of the UAV (over-riding the user controls). That is, rather than merely over-riding a user control to limit the altitude of the UAV, or over-riding a user control to limit the direction of the UAV to prevent it from entering prescribed airspace, the UAV may be designed such that an emergency-override signal may be received, permitting an appropriate official (e.g., air traffic control, law enforcement, etc.) to take direct control over the flight path of the UAV. In this regard, future laws may be promulgated requiring UAV manufacturers to provide this ability of UAVs, upon receipt of an certain encoded signal (the encoding not known by the public).

In yet other embodiments, the altitude restrictions described above may also include minimum altitude restrictions, as well as maximum altitude restrictions. That is, in additional to maximum altitude restrictions in certain areas (e.g., 1,000 feet) to prevent interference with commercial and other aviation air traffic, the UAV may be required to maintain certain minimum altitude restrictions over certain areas. For example, when flying over residential or populated areas, there may be a minimum altitude imposed to protect the privacy of residences on the ground. Thus, if the user attempted to direct the UAV into flight over these areas, user controls would be over-ridden to cause the UAV to fly at least a minimum prescribed altitude.

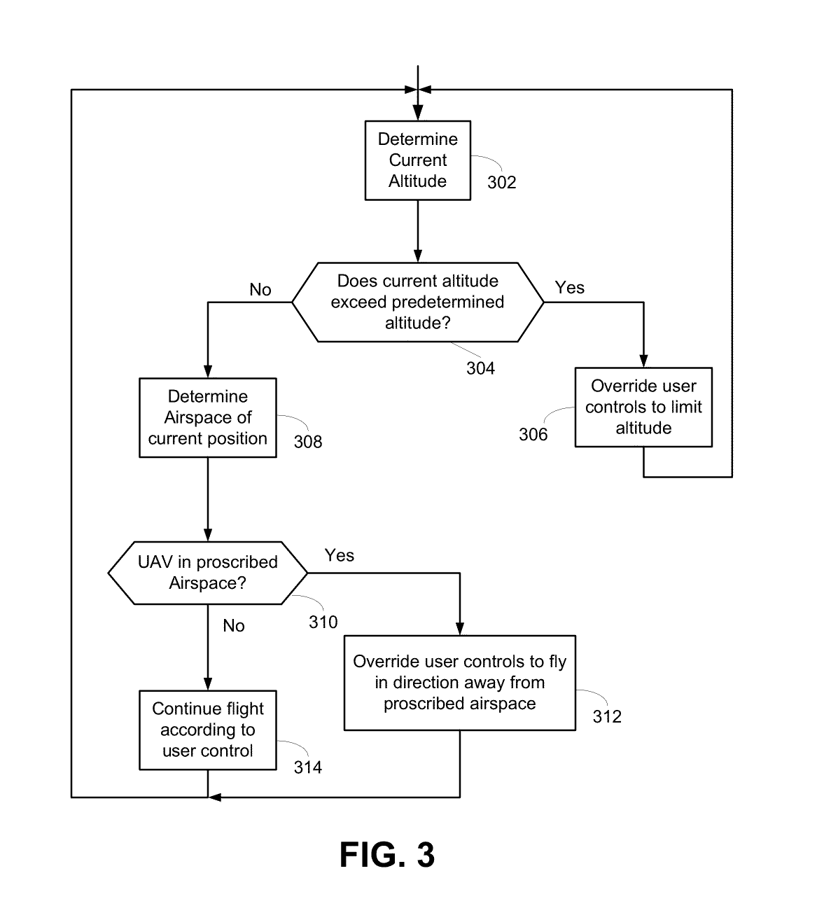

Reference is now made to FIG. 3, which is a flowchart illustrating certain steps or operations of a UAV constructed in accordance with an embodiment of the present invention. In this embodiment, a determination is made of the current altitude 302, and the determined altitude is assessed to ascertain whether it exceeds a predetermined, permissible altitude 304. If so, they UAV overrides user control inputs, and controls the flight of the UAV to limit its altitude 306.

If, however, step 304 resolves that the UAV is flying at a permissible altitude, then a determination is made as to the current airspace that the UAV is flying in 308. It is then determined 310 whether the UAV is currently flying in a proscribed airspace 310. If so, then user directional controls are overwritten, and the UAV is automatically flow in a direction away from the proscribed airspace 312. If it is determined that the UAV is not in a proscribed airspace, then flight is permitted to continue according to the user control 314.

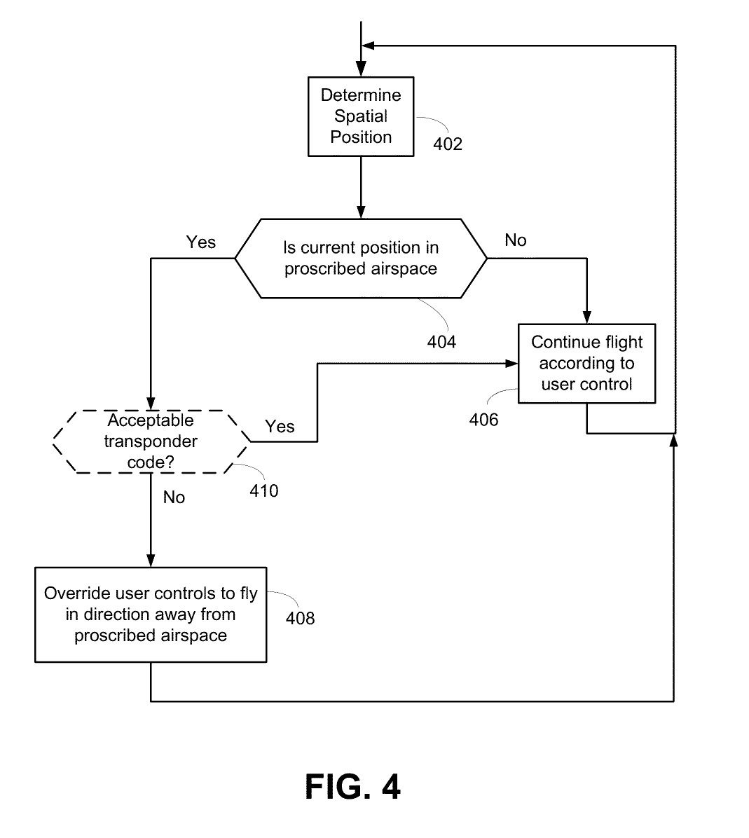

Reference is now made to FIG. 4, which is a flowchart illustrating certain steps or operations of a UAV constructed in accordance with an embodiment of the present invention. First, a spatial position of the UAV is determined 402. The current position is then assessed to determine whether it is in a proscribed airspace 404. If not, flight is continued according to user control 406. If, however, the UAV is determined to be in, or entering, a proscribed airspace, then the UAV overrides the user control inputs to fly in a direction away from the proscribed airspace 408.

An optional operation 410 is illustrated in dashed lines, whereby a determination is made as to whether the UAV is transmitting an acceptable transponder code. If not, user directional control is overridden in step 408. Otherwise, flight is permitted to continue (step 406) according to the user control templates.

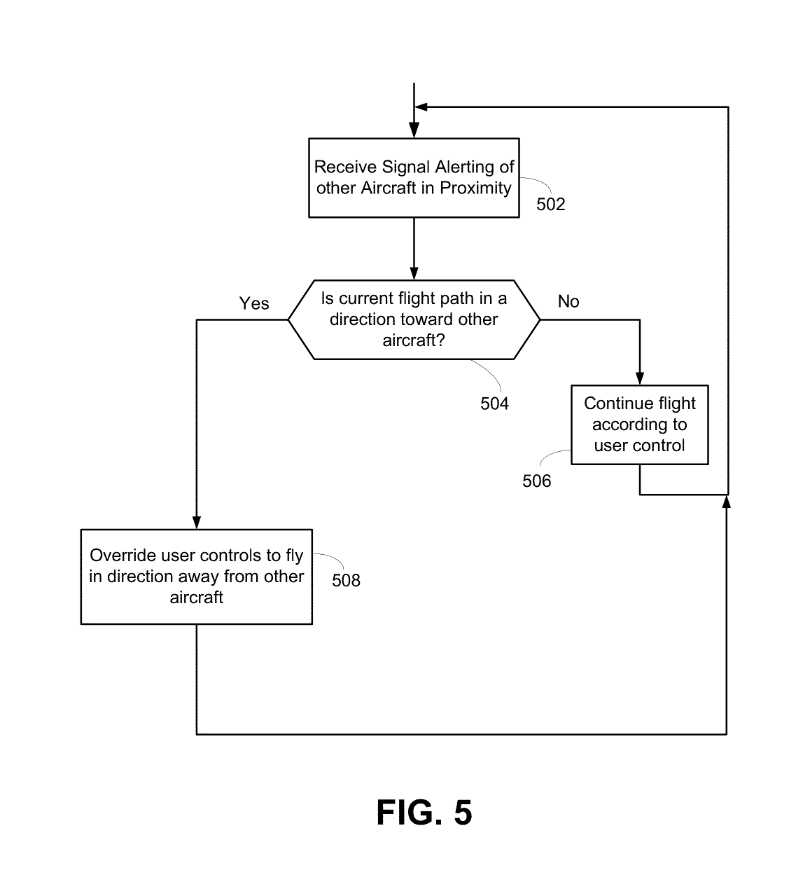

Reference is now made to FIG. 5, which is a flowchart illustrating operations of another embodiment of the invention. First, a signal is received (e.g., ADS-B, TCAS, TIS, etc.) alerting the UAV of another aircraft in the proximity of the UAV 502. As noted above, such a signal may be received from an S-mode transponder or from an ADS-B receiver. Then, the UAV determines whether its current flight path is in a direction toward the other aircraft (e.g., is the distance between the two closing?) 504. In this regard, a direction “toward” another could be computed as direct collision course, or more preferably a direction that would take the UTV to a location that is determined to be within a predetermined distance of the flight path of the other aircraft. If not, then flight is continued under user control 506. Otherwise, user control input signals are overridden and the UAV is flown in a direction away from the other aircraft 508.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure.

For example, with reference back to FIG. 2, additional circuits may be provided 190 to carry out the various functions or operations described herein, such as assessing the proximity of other aircraft that may be identified via an S-mode transponder or ADS-B signal, assessing whether the current direction of the UAV is resulting in a closure of the distance with another aircraft, assessing the current transponder code, assessing/acting upon a traffic signal received via the transponder or auxiliary receiver/transmitter, etc.

All such modifications and variations are intended to be included herein within the scope of this disclosure and protected by the following claims.

I claim:

1. An unmanned aerial vehicle (UAV) comprising:
flight control components for controlling the speed, altitude, and direction of flight of the UAV;
a control circuit configured to generate flight control outputs that control the flight control components;
a receiver receiving flight control inputs from a remote controller, the received flight control inputs are utilized by the control circuit to generate the flight control outputs;
an altitude determining circuit configured to determine an altitude of the UAV;
altitude override circuit, embodied in the control circuit, operative when the altitude is determined to exceed a predetermined altitude limit, and configured to override conflicting flight control inputs and generate flight control outputs to control the flight control components to reduce the altitude of the UAV.

2. The UAV of claim 1, wherein the UAV is one selected from the group consisting of a fixed-wing aircraft, a helicopter, and a quad-copter.

3. The UAV of claim 1, wherein the altitude determining circuit comprises a global positional system (GPS) receiver circuit.

4. The UAV of claim 1, wherein the altitude determining circuit comprises circuitry that transmits a signal to be reflected off the ground, and circuitry for timing circuitry configured to time a return of the reflected signal.

5. The UAV of claim 1, further comprising a position determining circuit configured to determine a spatial location of the UAV;

6. The UAV of claim 1, further comprising direction override circuit, embodied in the control circuit, operative when the spatial location is determined to be in a proscribed airspace, and configured to override conflicting flight control inputs and generate flight control outputs to control the flight control components to alter the direction of the UAV, such that the altered direction of the UAV is away from the proscribed airspace.

7. An unmanned aerial vehicle (UAV) comprising:
flight control components for controlling the speed, altitude, and direction of flight of the UAV;
a receiver receiving flight control inputs from a remote controller, the received flight control inputs are utilized by the control circuit to generate the flight control outputs;
a control circuit configured to generate flight control outputs that control the flight control components;
position determining circuitry configured to determine a spatial location of the UAV;
direction override circuit, embodied in the control circuit, responsive to the determined spatial location, the direction override circuit is configured to override conflicting flight control inputs and generate flight control outputs to control the flight control components to alter the direction of the UAV, such that the altered direction of the UAV is away from the proscribed airspace.

8. The UAV of claim 7, wherein the altered direction is a vertical direction.

9. The UAV of claim 7, wherein the altered direction is a horizontal direction.

10. The UAV of claim 7, further comprising a transponder configured to emit a squawk code, wherein the direction override circuit, is additionally responsive to the squawk code of the transponder, such that flight control inputs are not overridden when the transponder emits an acceptable squawk code.

11. An unmanned aerial vehicle (UAV) comprising:
flight control components for controlling the speed, altitude, and direction of flight of the UAV;
a control circuit configured to generate flight control outputs that control the flight control components;
a receiver receiving traffic signals identifying other aircraft in the proximity of the UAV;
direction override circuit, embodied in the control circuit, responsive to a determination that the UAV is traveling in a direction toward another aircraft, the direction override circuit is configured to override conflicting flight control inputs and generate flight control outputs to control the flight control components to alter the direction of the UAV, such that the altered direction of the UAV is away from the another aircraft.

12. The UAV of claim 11, wherein the traffic signals include at least one selected from the group consisting of Automatic Dependent Surveillance-Broadcast (ADS-B) signals and Mode-S transponder signals.
